(19) United States
(12) Patent Application Publication
(10) Pub. No.: US 2012/0251194 A1
(43) Pub. Date: Oct. 4, 2012

(54) IMAGE FORMING APPARATUS

(75) Inventors: Masaaki TAKAHASHI, Kanagawa (JP); Yasuhiro SHIMADA, Kanagawa (JP)

(73) Assignee: FUJI XEROX CO., LTD., Tokyo (JP)

(21) Appl. No.: 13/269,109

(22) Filed: Oct. 7, 2011

(30) Foreign Application Priority Data
Mar. 28, 2011 (JP) 2011-071090

(51) Int. Cl. G03G 15/01

(52) U.S. Cl. 399/302

(57) ABSTRACT

An image forming apparatus includes an endless belt-like image holding member holding a visible image, a first offset correcting member rotatably supporting the endless belt-like image holding member and tilting a first rotation shaft in a direction in which an offset is corrected, an endless belt-like transport member supporting and transporting a medium, and a second offset correcting member rotatably supporting the endless belt-like transport member and tilting a second rotation shaft in a direction in which an offset is corrected, wherein the image holding member and the transport member satisfy a conditional expression of μ_{A}<μ_{B} where μ_{A} represents a first static friction coefficient between the surface of the image holding member and a predetermined medium and μ_{B} represents a second static friction coefficient between the surface of the transport member and the medium.

### CROSS-REFERENCE TO RELATED APPLICATIONS

This application is based on and claims priority under 35 USC 119 from Japanese Patent Application No. 2011-071090 filed Mar. 28, 2011.

### BACKGROUND

(i) Technical Field

The present invention relates to an image forming apparatus.

(ii) Related Art

A technique of employing an endless belt-like transport member, that is a transport belt, which holds and transports a medium having a visible image transferred to the surface thereof in a transfer area where the visible image is transferred to the medium in an image forming apparatus according to the related art is known in the related art.

### SUMMARY

According to an aspect of the invention, there is provided an image forming apparatus including: an endless belt-like image holding member of which a surface holds a visible image; a first offset correcting member that is formed of a rotating member having a first rotation shaft, that rotatably supports the endless belt-like image holding member, and of which the first rotation shaft is tilted in a direction in which an offset is corrected when the image holding member offsets in a width direction; an endless belt-like transport member that is disposed in a transfer area where the visible image on the surface of the image holding member is transferred to a medium and that supports and transports the medium on a surface; and a second offset correcting member that is formed of a rotating member having a second rotation shaft, that rotatably supports the endless belt-like transport member, and of which the second rotation shaft is tilted in a direction in which an offset is corrected when the transport member offsets in a width direction, wherein the image holding member and the transport member satisfy a conditional expression of μ_{A}<μ_{B} where μ_{A} represents a first static friction coefficient between the surface of the image holding member and a predetermined medium and μ_{B} represents a second static friction coefficient between the surface of the transport member and the medium.

### BRIEF DESCRIPTION OF THE DRAWINGS

Exemplary embodiments of the present invention will be described in detail based on the following figures, wherein:

FIG. 1 is a diagram illustrating the overall configuration of an image forming apparatus according to Example 1 of the invention; and

FIG. 2 is a diagram illustrating the partial configuration of a secondary transfer unit according to Example 1 of the invention.

### DETAILED DESCRIPTION

Hereinafter, specific examples (hereinafter, referred to as examples) of an exemplary embodiment of the invention will be described with reference to the accompanying drawings but the invention is not limited to the examples.

For the purpose of easy understanding of the following description, the front-rear direction in the drawings corresponds to the X axis direction, the horizontal direction corresponds to the Y axis direction, and the vertical direction corresponds to the Z axis direction. In addition, directions or sides indicated by arrows X, −X, Y, −Y, Z, and −Z corresponds to the front direction, the rear direction, the right direction, the left direction, the upper direction, and the lower direction, respectively, or the front side, the rear side, the right side, the left side, the upper side, and the lower side, respectively.

In the drawings, a mark in which “•” is marked in “O” means an arrow directed from the rear side of the drawing paper to the front side and a mark in which “×” is marked in “O” means an arrow directed from the front side of the drawing paper to the rear side.

In the following description with reference to the drawings, elements other than elements necessary for the description are not shown for the purpose of easy understanding.

### EXAMPLE 1

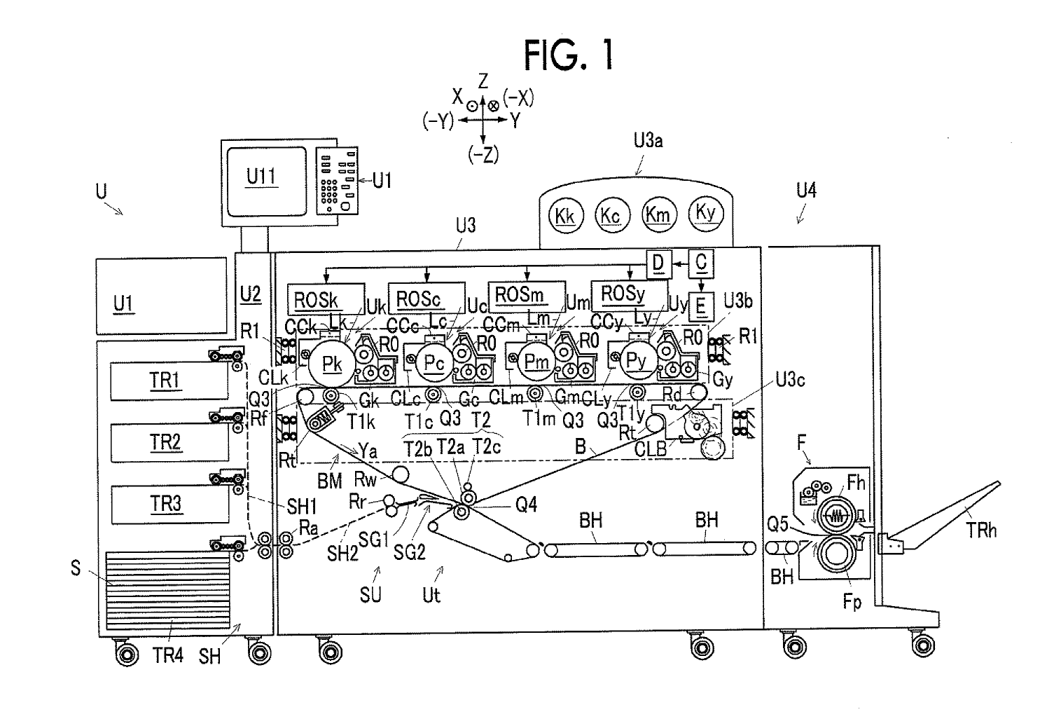

FIG. 1 is a diagram illustrating the overall configuration of an image forming apparatus according to Example 1 of the invention.

In FIG. 1 an image forming apparatus U includes an operation unit U1, a scanner device U1 as an example of an image reading unit, a sheet feed device U2, an image forming apparatus body U3, and a sheet discharge unit U4.

The operation unit U1 includes a power button, a copy start button, a copy number setting button, ten keys, and a display unit as an example of an input unit.

The scanner device U1 reads a document not shown, converts the read image into image information, and inputs the image information to the image forming apparatus body U3.

The sheet feed device U2 includes plural sheet feed trays TR1 to TR4 as an example of the sheet feed unit and a sheet feeding path SH1 through which a recording sheet S as an example of the medium picked up from the sheet feed trays TR1 to TR4 is transported to the image forming apparatus body U3.

In FIG. 1, the image forming apparatus body U3 includes a control unit C and a power supply circuit E that supplies power to the units of the image forming apparatus body U3 under the control of the control unit C. The control unit C receives the image information of a document read by the scanner device U1 or image information transmitted from a personal computer as an example of an information transmitter (not shown in the drawing) connected to the image forming apparatus U.

The control unit C processes the received image information into print information of yellow Y, magenta M, cyan C, and black K and outputs the processed information to a laser driving circuit D as an example of a driving circuit of a latent image writing device. The laser driving circuit D outputs a laser driving signal input from the control unit C to latent image forming devices ROSy, ROSm, ROSc, and ROSk at predetermined times.

Image holding member units Uy, Um, Uc, and Uk of Y, M, C, and K are disposed below the latent image forming devices ROSy to ROSk, respectively.

In FIG. 1, the black (K) image holding member unit Uk includes a photosensitive drum Pk as an example of the image holding member, a corotron CCk as an example of the charging device, and a photosensitive drum cleaner CLk as an example of the image holding member cleaner. Similarly, the image holding member units Uy, Um, and Uc of the other colors Y, M, and C include photosensitive drums Py, Pm, and Pc, corotrons CCy, CCm, and CCc, and photosensitive drum cleaners CLy, CLm, and CLc.

In Example 1, the K photosensitive drum Pk of which the use frequency is high and of which the surface is much abraded has a diameter larger than that of the other photosensitive drums Py, Pm, and Pc, thereby coping with a high-speed rotation and an elongation of lifetime.

The photosensitive drums Py, Pm, Pc, and Pk are uniformly charged by the corresponding corotrons CCy, CCm, CCc, and CCk and electrostatic latent images are formed on the surfaces of the photosensitive drums Py to Pk by the use of laser beams Ly, Lm, Lc, and Lk as an example of the latent image writing beam output from the latent image forming devices ROSy, ROSm, ROSc, and ROSk. The electrostatic latent images on the surfaces of the photosensitive drums Py, Pm, Pc, and Pk are developed into toner images as an example of the visible image with color developer of yellow Y, magenta M, cyan C, and black K by developing rolls R0 as an example of the developing member disposed in each of the developing devices Gy, Gm, Gc, and Gk.

The toner images on the surfaces of the photosensitive drums Py, Pm, Pc, and Pk are sequentially transferred and superimposed onto an intermediate transfer belt B as an example of the intermediate transfer member and an example of the image holding member in a primary transfer area Q3 by the use of primary transfer rolls T1y, T1m, T1c, and T1k as an example of the primary transfer device, whereby a multi-colored image, that is, a color image, is formed on the intermediate transfer belt B. The color image formed on the intermediate transfer belt B is transported to a secondary transfer area Q4.

In the case of black image data, only the black toner image is formed by the use of only the black (K) photosensitive drum Pk and the developing device Gk.

Residual toner remaining on the surfaces of the photosensitive drums Py, Pm, Pc, and Pk after the primary transfer are cleaned by the photosensitive drum cleaners CLy, CLm, CLc, and CLk.

The toner image forming members Uy+Gy, Um+Gm, Uc+Gc, and Uk+Gk as an example of the visible image forming unit are constructed by the image holding member units Uy, Um, Uc, and Uk and the developing devices Gy, Gm, Gc, and Gk as an example of the developing device.

A toner dispenser U3a as an example of a supply device is disposed on the image forming apparatus body U3 and toner cartridges Ky, Km, Kc, and Kk as an example of the developer container are detachably attached to the toner dispenser U3a. When the toner in the developing devices Gy to Gk are consumed with the formation of images, toner is supplied to the developing devices Gy to Gk from the toner cartridges Ky to Kk.

The intermediate transfer belt B disposed below the photosensitive drums Py to Pk is suspended by an intermediate transfer driving roll Rd as an example of the driving member of the intermediate transfer member, an intermediate transfer tension roll Rt as an example of the tension applying member applying a tension to the intermediate transfer belt B, an intermediate transfer steering roll Rw as an example of the first offset correcting member correcting offset or meandering of the intermediate transfer belt B, plural intermediate transfer idler rolls Rf as an example of the driven member of the intermediate transfer member, and a backup roll T2a as an example of the counter member in the secondary transfer area. The intermediate transfer belt B is supported by the driving of the intermediate driving roll Rd so as to be rotatable in the direction of arrow Ya.

A belt supporting roll Rd+Rt+Rw+Rf+T2a as an example of the intermediate transfer member supporting member in Example 1 is constructed by the intermediate transfer driving roll Rd, the intermediate transfer tension roll Rt, the intermediate transfer steering roll Rw, the intermediate transfer idler roll Rf, and the backup roll T2a. A belt module BM as an example of the intermediate transfer device is constructed by the intermediate transfer belt B, the belt supporting roll Rd+Rt+Rw+Rf+T2a, and the primary transfer rolls T1y to T1k. The belt module BM of Example 1 is formed as a unit detachable from and replaceable for the image forming apparatus body U3.

The intermediate transfer steering roll Rw of Example 1 is formed of a rotating member having a rotation shaft. The rotation shaft is tilted in a direction in which the offset is corrected depending on the offset in the width direction of the intermediate transfer belt B, thereby preventing the offset and the meandering of the intermediate transfer belt B. The steering roll Rw of a type of correcting the offset by tilting the rotation shaft depending on the detection result of a member detecting the offset of a belt, such as an optical sensor or a member coming in contact with an edge of the belt, that is, an active steering type, is known in the related art and various known configurations described in JP-A-2009-86463, JP-A-2010-231112, and the like can be employed. Accordingly, the details thereof will not be described.

A secondary transfer unit Ut as an example of the transfer and transport device is disposed below the backup roll T2a. The secondary transfer unit Ut includes a secondary transfer roll T2b as an example of the transfer member disposed to face the backup roll T2a and a secondary transfer area Q4 is formed by an area where the secondary transfer roll T2b faces the intermediate transfer belt B. In Example 1, the secondary transfer unit Ut is impelled in the direction in which the secondary transfer roll T2b is pressed down by the backup roll T2a by an impelling member not shown. A contact roll T2c as an example of a contact member for supplying a voltage comes in contact with the backup roll T2a. A secondary transfer device T2 is constructed by the rolls T2a to T2c.

A secondary transfer voltage having the same polarity as the charging polarity of the toner is applied to the contact roll T2c from the power supply circuit E controlled by the control unit C at a predetermined time

A sheet transporting path SH2 is disposed below the belt module BM. A recording sheet S fed from the sheet feeding path SH1 of the sheet feed device U2 is transported to the sheet transporting path SH2, is sent at the time of transporting the toner image to the secondary transfer area Q4 by the register roll Rr as an example of the sending member, is guided by sheet guides SG1 and SG2 as an example of a medium guiding member, and is transported to the secondary transfer area Q4.

The toner image on the intermediate transfer belt B is transferred to the recording sheet S by the secondary transfer device T2 at the time of passing through the secondary transfer area Q4. In the case of a color image, the toner images primarily transferred and superimposed to the surface of the intermediate transfer belt B are secondarily transferred to the recording sheet S at a time.

The intermediate transfer belt B after the secondary transfer is rubbed, that is, cleaned, by a belt cleaner CLB as an example of the intermediate transfer member cleaner. The secondary transfer roll T2b is supported so as to come in contact with and to be separated from the intermediate transfer belt B.

A transfer device T1+B+T2+CLB transferring the images on the surfaces of the photosensitive drums Py to Pk to the recording sheet S is constructed by the primary transfer rolls T1y, T1m, T1c, and T1k, the intermediate transfer belt B, the secondary transfer device T2, and the belt cleaner CLB.

The recording sheet S to which the toner image is secondarily transferred is held on the surface of an endless belt-like transfer and transport belt 1 as an example of the transfer and transport member suspended between the transfer belt supporting roll T2d as an example of the suspension member disposed downstream from the secondary transfer roll T2b and the secondary transfer roll T2b, and is then transported downstream.

Plural suction transport belts BH as an example of the transport member holding the recording sheet S on the surfaces thereof and transporting the recording sheet S downstream are disposed downstream from the transfer and transport belt T2e. The recording sheet S is transported downstream while adjusting the transport speed or the sheet interval by the use of the plural suction transport belts BH. Plural holes not shown are formed in the suction transport belts BH and fans as an example of a suction device suctions air through the holes, whereby the suction transport belts transport the recording sheet S suctioned to the surfaces thereof downstream. The suction transport belts are known in the related art and, for example, any configuration such as the configuration described in JP-A-2004-347880 can be employed. Accordingly, the details thereof will not be described herein.

The recording sheet S transported by the suction transport belts BH is transported to a fixing device F disposed in a sheet discharge unit U4 downstream. The fixing device F includes a heating roll Fh as an example of the heating fixing member and a pressing roll Fp as an example of the pressing fixing member, and a fixing area Q5 is formed by the area where the heating roll Fh and the pressing roll Fp come in contact with each other.

The toner image on the recording sheet S is heated and fixed by the fixing device F at the time of passing through the fixing area Q5. The recording sheet S to which the toner image is fixed by the fixing device F is discharged to a discharge tray TRh as an example of the discharge unit.

The sheet transporting path SH is constructed by SH1 and SH2. The sheet transporting device SU is constructed by SH, Ra, Rr, SG1, SG2, and BH.

### Secondary Transfer Belt

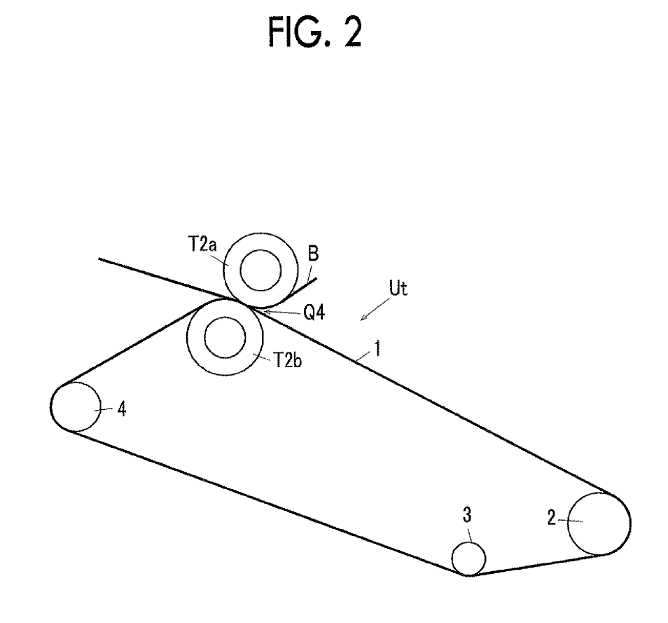

FIG. 2 is a diagram illustrating the partial configuration of the secondary transfer unit of Example 1.

In FIGS. 1 and 2, the secondary transfer unit Ut disposed in the secondary transfer area Q4 includes a transfer and transport belt 1 as an example of the endless belt-like transport member transporting the recording sheet S held on the surface thereof. The transfer and transport belt 1 is suspended by the secondary transfer roll T2b, a transfer and transport driving roll 2 as an example of the second driving member supplied with a driving force for rotationally driving the transfer and transport belt 1, a transfer and transport steering roll 3 as an example of the second offset correcting member correcting the offset or meandering of the transfer and transport belt 1, and a transfer and transport tension roll 4 as an example of the second tension applying member applying a tension to the transfer and transport belt 1.

Transport supporting rolls T2b and 2 to 4 as an example of the transport member supporting member of Example 1 are constructed by the transfer and transport driving roll 2, the transfer and transport steering roll 3, the transfer and transport tension roll 4, and the secondary transfer roll T2b.

The transfer and transport steering roll 3 of Example 1 is formed of a steering roll of an active steering type, similarly to the intermediate transfer steering roll Rw and various known configurations can be employed. Accordingly, the details thereof will not be described herein.

The transfer and transport belt 1 and the intermediate transfer belt B in Example 1 are set to satisfy μ_{A}<μ_{B}, where μ_{A} represents a first static friction coefficient of the surface of the intermediate transfer belt B with respect to a predetermined medium and μ_{B} represents a second static friction coefficient of the surface of the transfer and transport belt 1 with respect to the medium. That is, with respect to the same medium, the static friction coefficient μ_{B} of the surface of the transfer and transport belt 1 is set to be greater than the static friction coefficient μ_{A} of the surface of the intermediate transfer belt B.

Specifically, the transfer and transport belt 1 in Example 1 is formed of polyimide as an example of a resin material. The intermediate transfer belt B has a configuration in which a surface layer formed of polytetrafluoroethylene (PTFE) as an example of a material having higher releasability and a smaller static friction coefficient than those of abase layer is formed on the surface of the base layer formed of polyimide.

In Example 1, it is stated that the belts include polyimide and the configuration in which the surface layer of PTFE is formed on the surface of polyimide, but the invention is not limited to this example. Polyamide, polyimideamide, or materials which can be used as the intermediate transfer belt or the transfer and transport belt may be used. The surface layer is not limited to the PTFE, but may employ fluorine resins or materials having a small static friction coefficient. That is, any material satisfying the conditional expression μ_{A}<μ_{B} may be selected and employed.

It is stated above that the transfer and transport belt 1 has a single structure of polyimide, but the invention is not limited to this example. A multi-layered structure including a surface layer or an intermediate layer may be employed. Similarly, the intermediate transfer belt B is not limited to the two-layered structure of the base layer and the surface layer, but may have a multi-layered structure including three or more layers.

It is stated above that the conditional expression μ_{A}<μ_{B} is satisfied by selecting materials, but the invention is not limited to this example. The conditional expression μ_{A}<μ_{B} may be satisfied by forming unevenness or grooves on the surface or the conditional expression μ_{A}<μ_{B} may be satisfied by using the same material but performing different surface processes.

It is stated above that the transfer and transport belt 1 and the base layer of the intermediate transfer belt B are formed of the same material, but the invention is not limited to this example and they may be formed of different materials.

### OPERATION OF EXAMPLE 1

In the image forming apparatus U according to Example 1 having the above-mentioned configuration, the toner images formed on the photosensitive drums Py to Pk are transferred to a recording sheet S in the secondary transfer area Q4 via the intermediate transfer belt B. The recording sheet S to which the toner images are transferred is supported on the surface of the transfer and transport belt 1, is transported downstream, is sent to the suction transport belts BH, is subjected to the fixing of the toner images by the fixing device F, and is then discharged to the discharge tray TRh.

In Example 1, two belts of the intermediate transfer belt B and the transfer and transport belt 1 are disposed to face each other in the secondary transfer area Q4.

In general, when the endless belt-like member is suspended and used by the plural rotating members, the belt may offset or meander depending on the parallelism of the rotating members. When it is intended to correct the offset by the use of a method of regulating the offset or meandering by forming a rib in the edge of the transfer and transport belt and the like, the offset of a rapidly-rotating belt or a short belt having a small circumference cannot be corrected and the transfer and transport belt may excessively offset and may be broken. Accordingly, in order to raise the rotation speed and to achieve the elongation of lifetime, it is preferable that the length of the belt be great, the transfer and transport belt 1 be supported by plural supporting rolls T2b and 2 to 4 as in Example 1, and the transfer and transport steering roll 3 of an active steering type be used to suppress the offset and meandering.

Here, when the steering rolls Rw and 3 of an active steering type are used for the transfer and transport belt 1 in addition to the intermediate transfer belt B, the offset of the transfer and transport belt 1 may be corrected to one end in the width direction thereof in a state where a recording sheet S is not present in the secondary transfer area Q4 and the offset of the intermediate transfer belt B is corrected to the other end in the width direction thereof. Accordingly, there is a problem in that the belts B and 1 move in the opposite directions in the secondary transfer area Q4. When the belts B and 1 move in the opposite directions, the belts B and 1 may slide relative to each other to be abraded and one of the belts B and 1 may be drawn by the other due to the frictional force therebetween to adversely affect the correction of offset. When the correction of offset is adversely affected, the belts B and 1 may be broken or the rotational behavior of the belts B and 1 may not be stabilized, thereby causing the deterioration in image quality such as a positional deviation (color deviation) of an image transferred to the intermediate transfer belt B or the bending due to the speed variation of the belts B and 1.

Therefore, in the image forming apparatus according to the related art, it can be considered that it is possible to reduce the offset interference of the intermediate transfer belt and the transfer and transport belt by giving the releasability to the transfer and transport belt, thereby preventing the color deviation or the bending. However, when the releasability is given to the transfer and transport belt, a sheet transporting force may be reduced to cause image shrinkage (a decrease in longitudinal magnification). Accordingly, the configuration in which the transfer and transport belt 1 supported by the transfer and transport steering roll 3 of an active steering type is used as the transfer and transport belt 1 facing the intermediate transfer belt B is not employed up to now.

On the contrary, in Example 1, the steering rolls Rw and 3 of an active steering type are used for both the intermediate transfer belt B and the transfer and transport belt 1 to correct the offset and meandering, and the surface layer having high releasability is formed on the surface of the intermediate transfer belt B. Accordingly, even when the belts B and 1 move in the opposite directions in the state where a recording sheet S is not present in the secondary transfer area Q4, it is possible to suppress one belt from being drawn by the other belt due to the frictional force, thereby suppressing the adverse influence on the correction of offset. Therefore, it is possible to suppress the belts B and 1 from being broken, to easily stabilize the rotating behavior thereof, and to suppress the generation of the positional deviation (color deviation) of an image and the like.

In Example 1, the static friction coefficients μ_{A} and μ_{B} of two belts B and 1 are set to satisfy μ_{A}<μ_{B}. Accordingly, even when forces in the opposite directions act on the front surface and the rear surface of a recording sheet S, the intermediate transfer belt B first slides over the recording sheet S. Accordingly, the generation of wrinkles or the breaking of the recording sheet S is suppressed.

If μ_{A}<μ_{B}, that is, if the surface layer of a fluorine resin or the like is formed on the transfer and transport belt instead of the intermediate transfer belt, the transfer and transport belt 1 first slides over the recording sheet S and thus the force for transporting a recording sheet S is reduced, thereby causing a problem with the image shrinkage and the like. On the contrary, in Example 1, since the static friction coefficients are set to satisfy μ_{A}<μ_{B}, the transporting force of the recording sheet S is not reduced well and the generation of a problem with the image shrinkage and the like is reduced.

The transfer and transport belts according to the related art are often supported by two supporting members as described in Japanese Patent No. 3575729 ([0021] and [0022] and FIG. 2) and JP-A-2006-030778 ([0013] and [0114] and FIGS. 2 and 4). When two supporting members are employed and the transfer and transport belts are elongated with the lapse of time, a tension may not be guaranteed in a long transfer and transport belt and thus the circumference of the transfer and transport belt is often set to be relatively small. When such a transfer and transport belt according to the related art is used and the number of prints per unit time increases to cause the transfer and transport belt to rotate at a high speed, the frictional sliding or abrasion per unit length increases due to the small circumference, thereby shortening the lifetime. In addition, the transfer and transport belt easily offsets and meanders, thereby causing a problem in that a load is easily applied to the transfer and transport belt. On the contrary, in Example 1, since the transfer and transport belt 1 is supported by plural supporting rolls T2b and 2 to 4 and the circumference is thus large, it is possible to elongate the lifetime in spite of the high-speed rotation.

In the image forming apparatus U according to Example 1, since the intermediate transfer belt B includes plural layers and the releasability is given to only the front surface, it is possible to prevent the slip between the belt supporting roll Rd+Rt+Rw+Rf+T2a and the intermediate transfer belt B, which is caused when the releasability is given to the rear surface.

### Modifications

The examples of the invention is described above in detail, but the invention is not limited to the examples and may be modified in various forms without departing from the concept of the invention described in the appended claims. Modifications (H01) to (H05) of the invention are described below.

(H01) Although it is stated in the examples that the copier U is used as an example of the image forming apparatus, the invention is not limited to the copier and may be applied to a printer, a FAX, or a multi-function machine having plural functions. The invention is not limited to the multi-color image forming apparatus, but may be applied to a monochromatic image forming apparatus.

(H02) Although it is stated in the examples that the drum-like photosensitive member is used as an example of the image holding member, the invention is not limited to this configuration and may employ an endless belt-like photosensitive member.

(H03) The specific numerical values or material names described in the examples maybe arbitrarily changed depending on the design or specification.

(H04) The number or positions of the transfer and transport supporting rolls T2b and 2 to 4 in the examples may be changed depending on the design or specification.

(H05) Although it is stated in the examples that the transfer and transport steering roll 3 and transfer and transport tension roll 4 are disposed at different positions, the invention is not limited to this configuration and, for example, the function of the transfer and transport steering roll 3 may be given to the transfer and transport tension roll 4 to used them in common.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an endless belt-like image holding member of which a surface holds a visible image;
a first offset correcting member that is formed of a rotating member having a first rotation shaft, that rotatably supports the endless belt-like image holding member, and of which the first rotation shaft is tilted in a direction in which an offset is corrected when the image holding member offsets in a width direction;
an endless belt-like transport member that is disposed in a transfer area where the visible image on the surface of the image holding member is transferred to a medium and that supports and transports the medium on a surface; and
a second offset correcting member that is formed of a rotating member having a second rotation shaft, that rotatably supports the endless belt-like transport member, and of which the second rotation shaft is tilted in a direction in which an offset is corrected when the transport member offsets in a width direction,
wherein the image holding member and the transport member satisfy a conditional expression of μ_{A}<μ_{B} where μ_{A} represents a first static friction coefficient between the surface of the image holding member and a predetermined medium and μ_{B} represents a second static friction coefficient between the surface of the transport member and the medium.

2. The image forming apparatus according to claim 1, wherein the image holding member includes a base layer and a surface layer that is formed on a surface of the base layer and that is formed of a material having a static friction coefficient smaller than that of the base layer, and
wherein the transport member has a surface formed of the same material as the base layer.

3. The image forming apparatus according to claim 2, wherein the base layer of the image holding member and the surface of the transport member are formed of polyimide, and
wherein the surface layer is formed of polytetrafluoroethylene.
